(19) United States
(12) Patent Application Publication
(10) Pub. No.: US 2005/0261387 A1
(43) Pub. Date: Nov. 24, 2005

(54) Noise suppression structure manufacturing method

(76) Inventors: James F. Stevenson, Morristown, NJ (US); Jeff M. Mendoza, Chandler, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/851,974

(22) Filed: May 20, 2004

(51) Int. Cl. C08J 9/00

(52) U.S. Cl. 521/99

(57) ABSTRACT

An open cell foam bulk absorber is formed by pressurizing a foaming agent and a foamable material, and then decompressing the foaming agent and the foamable material. During decompression, the foamable material and foaming agent expand, and a plurality of open cells are formed in the foamable material, thereby producing an open cell foam bulk absorber. The open cells in the bulk absorber have a distribution of sizes about a mean size, and a density gradient.

### FIELD OF THE INVENTION

The present invention relates to noise suppression structures and, more particularly, to methods of making noise suppression structures for aircraft ducts and plenums.

### BACKGROUND OF THE INVENTION

Many aircraft are powered by jet engines. In most instances, jet engines include one or more gas-powered turbine engines, auxiliary power units (APUs), and/or environmental control systems (ECSs), which can generate both thrust to propel the aircraft and electrical energy to power systems installed in the aircraft. Although aircraft engines are generally safe, reliable, and efficient, the engines do exhibit certain drawbacks. For example, the turbine engines, as well as other components that make up the engine, can be sources of unwanted noise, especially during aircraft take-off and landing operations. Moreover, APUs and ECSs can be sources of unwanted ramp noise. Thus, various governmental rules and regulations aimed at mitigating such noise sources have been enacted.

To address, and at least somewhat alleviate, the unwanted noise emanating from aircraft noise sources, and to thereby comply with the above-noted rules and regulations, various types of noise reduction treatments have been developed. For example, one type of noise reduction treatment that has been developed for use in aircraft ducts is a noise suppression panel. In many instances, noise suppression panels are flat or contoured, and include a honeycomb structure disposed between a backing plate and a face plate. Other noise suppression materials and structure may also be disposed between the backing plate and face plate. The noise suppression panels are typically placed on the interior surface of engine or APU inlet and/or outlet plenums, as necessary, to reduce noise emanations.

Although the above-described noise suppression panels do exhibit fairly good noise suppression characteristics, the panels also exhibit certain drawbacks. For example, the honeycomb structure can be costly to manufacture, and difficult to conform to contoured surfaces. The honeycomb structure can also be difficult to bond to the backing plate and/or face plate. Moreover, the honeycomb structure used in these panels is typically uniform in size and shape, which can result in the noise suppression panel being highly effective over only a relatively narrow frequency range.

### SUMMARY OF THE INVENTION

The present invention provides methods of making a noise suppression panel that can be readily bonded to backing and/or face plates, and is effective over a relatively wide frequency range.

In one embodiment, and by way of example only, a method of forming a foam includes pressurizing a foaming agent and a foamable material in a closed vessel. The foaming agent and the foamable material are then decompressed, whereby a foam having a plurality of cells is formed.

Other independent features and advantages of the preferred noise suppression panel manufacturing methods will become apparent from the following detailed description, taken in conjunction with the accompanying drawings which illustrate, by way of example, the principles of the invention.

### BRIEF DESCRIPTION OF THE DRAWINGS

FIG. 1 is a simplified perspective view of a noise suppression panel according to an exemplary embodiment of the present invention;

FIG. 2 is a cross section side view of the exemplary noise suppression panel shown in FIG. 1;

FIGS. 3A-3D are simplified schematic representations of an exemplary machine, and a process using the machine, for making the noise suppression panel of FIGS. 1 and 2, according to one embodiment of the present invention;

FIG. 4 is a perspective view of an exemplary mold cavity that may be used with the machine of FIGS. 3A-3D;

FIG. 5 is a photomicrograph depicting the cell structure formed by the exemplary process of the present invention;

FIG. 6 is a graph depicting sound absorption characteristics of a foam bulk absorber produced in accordance with an embodiment of the present invention; and

FIGS. 7A-7C are schematic representations of three parts of scaled up tooling that may be used for production of large foam bulk absorbers in accordance with an embodiment of the present invention.

### DETAILED DESCRIPTION OF A PREFERRED EMBODIMENT

Before proceeding with the detailed description, it is to be appreciated that the described embodiment is not limited to use in conjunction with a particular type of engine, or in a particular type of vehicle. Thus, although the present embodiment is, for convenience of explanation, described as being implemented in an aircraft environment, it will be appreciated that it can be implemented in various other types of vehicles, and in various other systems and environments.

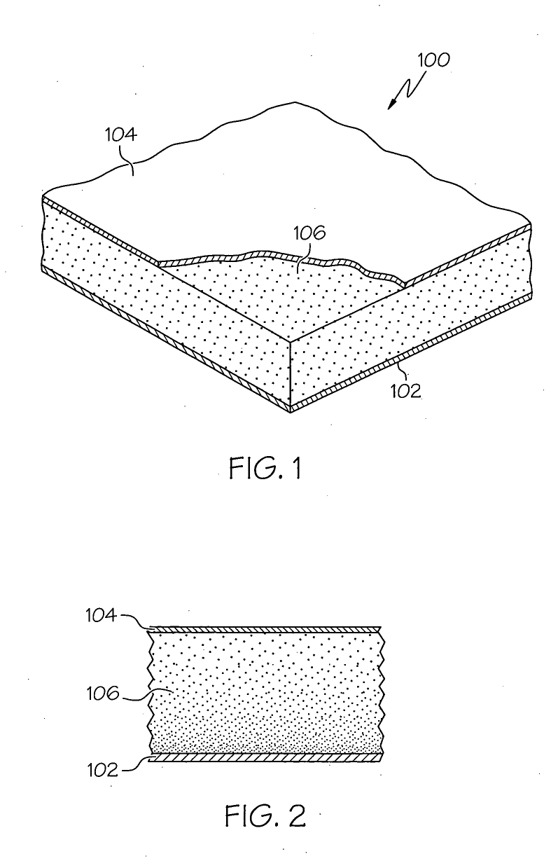

Turning now to the description, and with reference first to FIGS. 1 and 2, an exemplary noise suppression panel 100 is depicted in perspective and cross section, respectively. The panel 100 includes a back plate 102, a face plate 104, and a foam bulk absorber 106. The back plate 102 is preferably imperforate and is constructed of any one of numerous types of non-porous materials such as, for example, aluminum. In a particular preferred embodiment, however, the back plate 102 is constructed of bismaleimide (BMI). As will be described more fully below, the back plate 102 is preferably bonded directly to the foam bulk absorber 106 during manufacture of the panel 100.

The face plate 104 is constructed of any one of numerous types of materials such as, for example, aluminum, and carbon composites. In a particular preferred embodiment, however, the face plate 104 is constructed of BMI, and is perforated to a desired percent open area (POA) value. As is generally known, relatively low POA values (e.g., ˜5%) provide acoustic resistance, whereas relatively high POA values (e.g., ˜30%) provide acoustic transparency. In a particular preferred embodiment, the face plate 104 is perforated to a POA value greater than about 30% to ensure the face plate 104 is acoustically transparent to any incident sound. Similar to the back plate 102, and as will be described further below, the face plate 104 is also preferably bonded to the foam bulk absorber 106 during manufacture of the panel 100.

The foam bulk absorber 106 is disposed between the back plate 102 and face plate 104 and, as was mentioned above, is preferably directly bonded to each plate 102, 104 during manufacture of the panel 100. The foam bulk absorber 106, following fabrication, is preferably open cell foam. Thus, it is preferably constructed of a foamable material. Some non-limiting examples of these materials include various thermoset materials, such as bismaleimide (BMI) or phenolic, various ceramic powder compounds, such as alumina or zirconia, and various metal powder compounds, such as 316L stainless steel, or carbonyl iron and nickel compounds. The thermoset materials are preferably used for relatively low temperature applications (e.g., 200-400° F.), and the ceramic or metal powder compounds are preferably used for relatively high temperature applications (e.g., 1200-1500° F.). Moreover, when the ceramic or metal powder compounds are used, a binder may additionally be included. Non-limiting examples of such binders include agar gels, polystyrene, or other polymer/wax combinations.

With reference now to FIG. 2, it is seen that in a particular preferred embodiment the foam bulk absorber 106 has a density gradient between the back plate 102 and face plate 104. In particular, the density of the foam bulk absorber 106 decreases from the interface with the back plate 102 to the interface with the face plate 104. Moreover, the manufacturing process, various embodiments of which are described in more detail below, creates foam with a plurality of open cells having a distribution of sizes about a mean size. This distribution of cell sizes results in an increased frequency range over which the foam bulk absorber 106 is effective. The performance of the foam bulk absorber 106 is further enhanced by the above-mentioned density gradient between the face plate 104 and back plate 102.

The integrated noise suppression panel 100 described above is manufactured by first subjecting a foaming agent and a foamable material to pressure in a closed vessel. The foaming agent and amount used may vary, depending on the desired characteristics of the final bulk absorber material, the foamable material used, operating conditions, and equipment capabilities. Some non-limiting examples of foaming agents that may be used include CO₂, N₂, water, sodium bicarbonate and acid, or various other high-temperature agents. No matter the particular combination of foaming agent and foamable material selected, following pressurization the foaming agent and foamable material are allowed to undergo a relatively rapid decompression. As a result of the rapid decompression, and when certain other conditions are satisfied, which are described in more detail below, a plurality of open cells are formed in the foamable material, and the open cell foam bulk absorber 106 is formed. Depending on the particular process used, the foam bulk absorber 106 may be bonded to the back plate 102 and the face plate 104 either during or after the manufacturing process.

Various equipment arrangements and specific processes may be used to implement the general manufacturing process described above. Two exemplary equipment arrangements and the specific processes are disclosed herein. The first equipment arrangement is preferably used for relatively small-scale projects, such as for process development. Conversely, the second arrangement is preferably used for large-scale projects, such as for factory production.

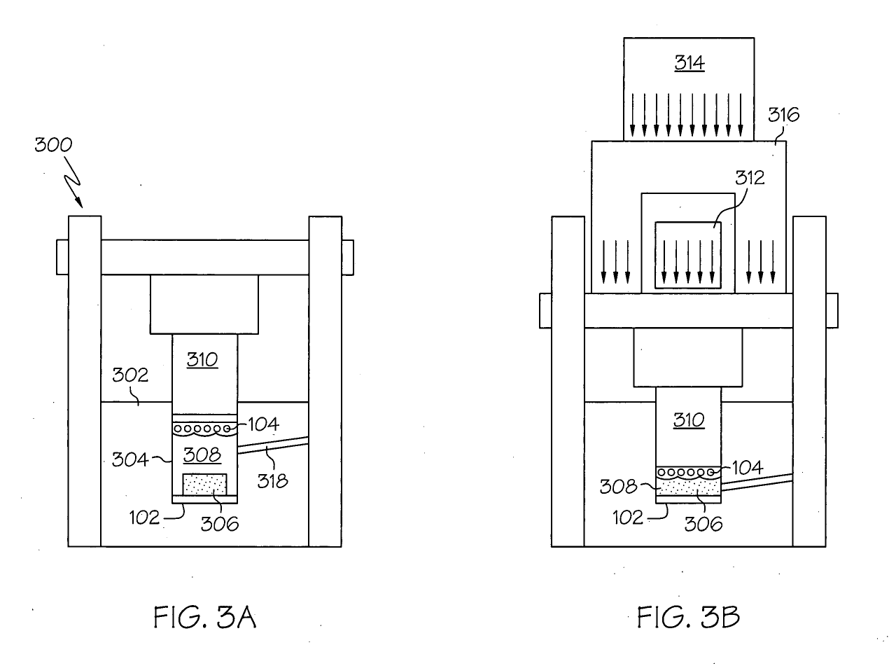

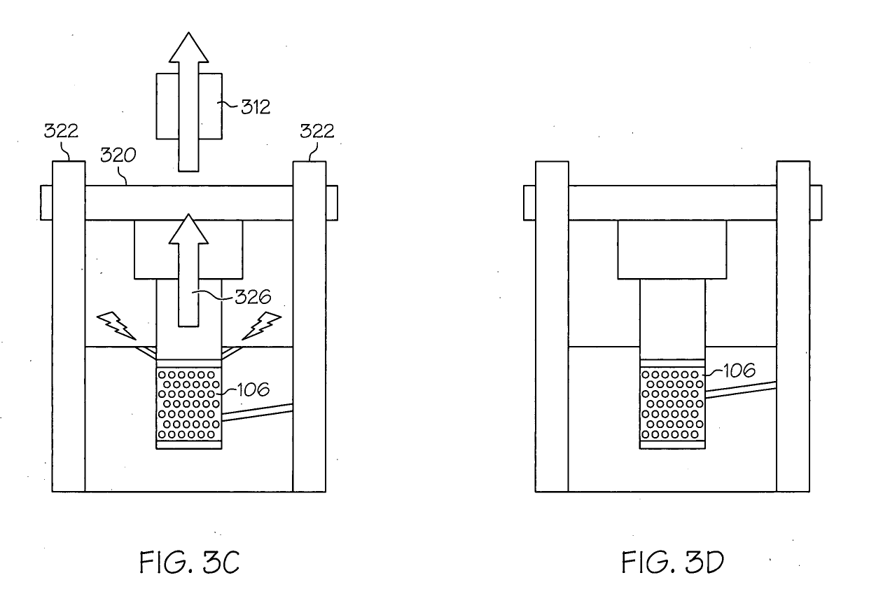

Turning first to FIGS. 3A-3D, a process that uses a rapid release compression molding machine 300 will be described. With particular reference to FIG. 3A, a mold 302 having a cavity 304 with a desired shape and dimensions is placed in the machine 300. A charge of foamable material 306 is placed within the mold cavity 304. A piston 310 is then moved partially into the mold cavity 304. In the depicted embodiment, the back plate 102 and face plate 104 are also placed within the mold cavity 304, one above and one below the foamable material charge 306. However, it will be appreciated that one or both plates 102, 104 could be absent. Although the back plate 102 is shown as being disposed in the mold cavity 304 below the foamable material charge 306, and the face plate 104 above the foamable material charge 306, it will be appreciated these positions could be reversed. No matter the particular positions of the plates 102, 104, it will be appreciated that the plate 102, 104 disposed above the foamable material charge 306 may be anchored in the mold cavity 304 in any one of numerous ways. For example, the plate 102, 104 could be attached to the piston 310. Alternatively, the plate 102, 104 could be supported from above by a grid of thin rods (not shown) that are anchored in a wall of the mold 302 and extend into the mold cavity 304. In another alternative embodiment, a small cylindrical mold having bottom and top surfaces consisting of the back plate 102 and the face plate 104, respectively, is used.

A foaming agent 308 is also placed in the mold cavity 304. However, how and when the foaming agent 308 is placed in the mold cavity 304 may depend upon the type of foaming agent 308 used. For example, if the foaming agent 308 is a chemical agent, such as sodium bicarbonate and acid, the foaming agent is preferably dispersed within the foamable material charge 306. Conversely, if the foaming agent 308 is a physical foaming agent, such as CO₂ or N₂ gas, then the foamable material charge 306 is first sealed in the mold cavity 304 with the piston 310. Thereafter, the mold cavity 304 is pressurized through a channel 318 with the CO₂ or N₂ gas, which saturates the foamable material charge 306. It will be appreciated that when physical foaming agents are used, it is preferable that the foamable material charge 306 be in a granular or powdered form to reduce the diffusion time that may be needed for the physical foaming agent 308 to dissolve uniformly throughout the foamable material charge 306.

A particularly convenient form of a physical foaming agent 308 is solid CO₂. In such an embodiment, a predetermined amount of solid CO₂ is added to the mold cavity 304, which is then sealed with the piston 310. The solid CO₂ sublimes to a gas, which, depending on the amount of the solid CO₂ relative to the size of, and the temperature in, the mold cavity 304, generates a pressure. It will be appreciated that the generated pressure can be relatively high, e.g. greater than 6000 psi. This method of generating a relatively high pressure is very convenient since pressures significantly higher than those obtainable with gas cylinders (e.g. 829 psi for CO₂ at 20° C.) can be obtained without the use of separate pressurization equipment.

Once the charge of foamable material 306, preferably in powder form, and the foaming agent 308 are placed in sealed the mold cavity 304, the machine 300 is then subject to a predetermined temperature change over a predetermined time period, which will vary depending on the type of the foamable material charge 306. In particular, the temperature-time relation is preferably selected to accommodate both the need to allow the foaming agent 308 to diffuse into the foamable material 306, and for the foamable material 306 to obtain sufficient mechanical properties, either through reaction, if the material is a thermoset, or by temperature reduction, if the material is a thermoplastic. In one particular exemplary embodiment, in which the foamable material 306 is powdered bismaleimide (BMI) and the foaming agent 308 is CO₂, the machine 300 is raised to 165° C. from room temperature over approximately a 30-minute period. During this time the CO₂ sublimes, pressurizing the mold cavity 304 to a pressure between about 800 and 2000 psi, and diffuses into the powdered BMI prior to its melting. The powdered BMI, now saturated with gas, is maintained at 165° C. for about 30 minutes to achieve sufficient mechanical properties, due to partial cure, so that the foam will not collapse upon pressure release.

Referring now to FIG. 3B, once the piston 310 is moved to the desired position within the mold cavity 304, a toggle clamp 312, and/or other appropriate devices, such as a hydraulic cylinder 314 and a yolk 316, are positioned over the piston 310 to hold it in place. Following pressurization, the foamable material 306 and foaming agent 308 are then held in the pressurized state for a predetermined time period, which may vary depending on the combination of foamable material 306 and foaming agent 308 used. For example, when powdered BMI was used as the foamable material 306, it was precured for about 105 minutes at about 150° C. so its viscosity would be high enough to prevent settling of a reinforcement material that was added to the BMI, which in this case was powdered carbon fibers. At room temperature, the precured BMI solid was granulated. It will be appreciated that the addition of the reinforcement material in the described example is merely exemplary and can be omitted.

It will be appreciated that in some instances the piston 310 may be further moved within the mold cavity 304 following pressurization, to thereby further pressurize the charge of foamable material 306 and foaming agent 308. Such an instance is depicted in FIG. 3B. It will be appreciated that the amount of compression and magnitude to which the foamable material 306 and foaming agent 308 are pressurized may vary, depending upon the combination of foamable material 306 and foaming agent 308 used. For example, in one exemplary embodiment the volume of the mold cavity 304 was reduced from 60 to 25 cubic centimeters/mole (28 grams) of CO₂ by using a hydraulic pump (not illustrated) to move the piston 310 over a 17-min time period. During this time, the temperature drifted down from 120° C. to 90° C.; however, even with this temperature decrease the pressure increased from about 3500 psi to about 6300 psi.

As shown in FIG. 3C, after the foamable material 306 and foaming agent 308 have been pressurized for the desired amount of time, the yolk 316 and hydraulic cylinder 314 are removed and the toggle clamp 312 is released. As a result, the internal pressure rapidly raises the piston 310, decompressing the foamable material 306. In an alternative embodiment, pressure in the mold cavity 304 can be released more slowly by releasing the pressure on the hydraulic cylinder 314 that holds the yolk 316 in place. In either case, the piston 310 is decelerated and stopped when a cross-member 320 encounters rubber bumpers at the top of a slot (not shown) in vertical guideposts 322. The travel of the piston 310 is sufficient to allow the gas to vent outside the mold cavity 304.

The rapid decompression described above allows the pressurized charge of foamable material 306 and foaming agent 308 to decompress, and undergo a rapid expansion in the fixed volume of the mold cavity 304. As was previously described, a plurality of open cells having a distribution of sizes about a mean size are formed in the foamable material 306 during this rapid decompression, thereby forming the open cell foam bulk absorber 106. If, as was previously mentioned, the back plate 102 and the face plate 104 are positioned at opposite ends of the mold cavity 304, an “uncured” noise suppression panel 100 is formed between the plates 102, 104. Thereafter, as represented in FIG. 3D, the foam bulk absorber 106 undergoes a final curing process by once again heating the foam bulk absorber 106 in the mold 302 over a predetermined period of time. This final curing process may vary, depending on the type of foamable material 306 that is used. In any case, once the predetermined period of time has elapsed, the mold 302 and foam bulk absorber 106 are cooled to room temperature. It will be appreciated that if the molded panel is a powdered metal or ceramic with binder, the foam is preferably sintered as part of a separate process.

In one particular exemplary embodiment of the above-described process, a 27-g charge of powdered BMI and 0.5 g of a powdered carbon fiber reinforcement material was mixed to form the charge of foamable material 306. The foamable material 306 and an 8.7 g charge of solid CO₂, which was used as the foaming agent 308, were placed in the mold cavity 304. The piston 310 was positioned such that the mold cavity volume was approximately 92 cubic centimeters. The mold cavity 304 was then heated from room temperature to 165° C. over a period of about 29 minutes, during which time the CO₂ pressurized the mold cavity 304 to about 1050 psi. The foamable material 306 was then cured for an additional 30 minutes at 165° C. Thereafter, the mold cavity 304 was vented rapidly by releasing the hydraulic cylinder, forming the foam bulk absorber 106. The temperature of the depressurized foam bulk absorber 106 was then raised to 200° C. for 1 hour to complete the cure cycle. The mold 302 was then allowed to cool back to room temperature and the foam bulk absorber 106 was removed.

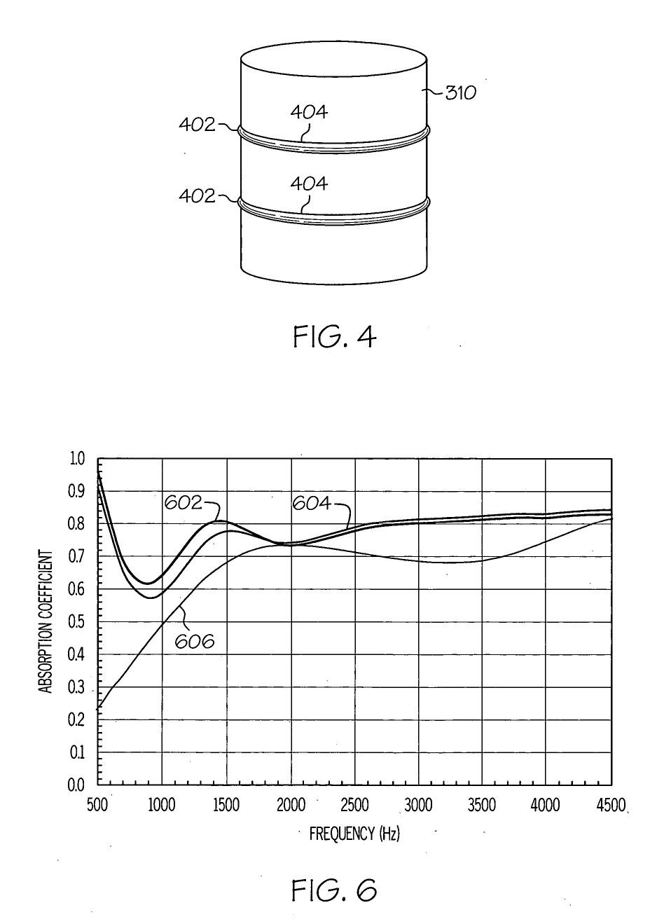

The machine 300 depicted in FIGS. 3A-3D is preferably configured to contain relatively high pressures, e.g., up to at least 3500 psi, at elevated temperatures of at least 200° C. Thus, as shown in FIG. 4, a pair of elastomeric O-rings 402 made of a special ethylene propylene elastomeric compound E0962-90, developed for oil well environments by Parker Seals of Lexington, Ky., are disposed on the piston 310. In particular, the pair of elastomeric O-rings 402 are disposed in grooves 404 formed on the piston 310. The O-rings help seal against pressure, and also help center the piston 310 to avoid scoring the walls of the mold cavity 304 (not shown in FIG. 4).

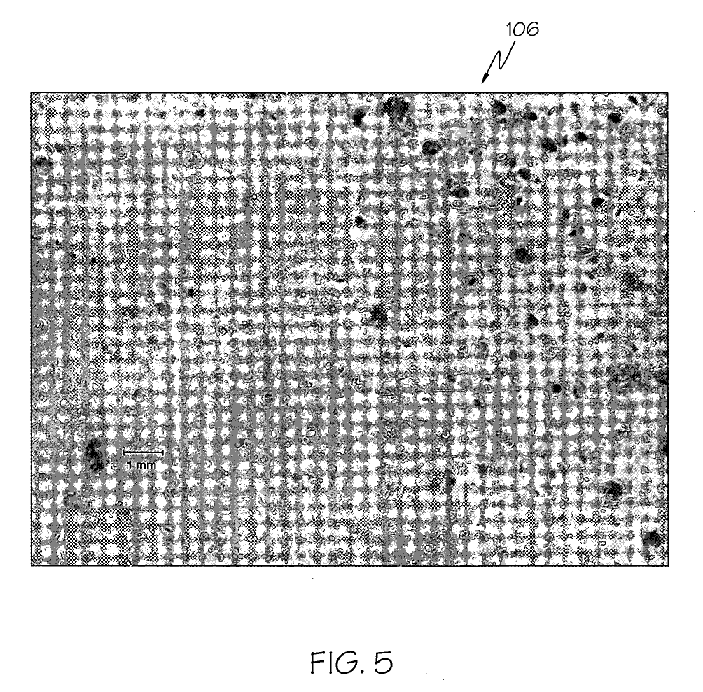

A photomicrograph of a foam bulk absorber 106 produced by the above-described machine 300 and process is depicted in FIG. 5. As shown therein, the foam bulk absorber 106 has open cells. The acoustic properties of this foam bulk absorber 106 were measured using standard test procedures (e.g., ASTM E 1050-98). The testing was performed twice to obtain separate measurements 602, 604 for each face of the absorber 106 toward a sound source. The calculated absorption coefficients 602, 604 are shown compared with packing foam 606 in FIG. 6.

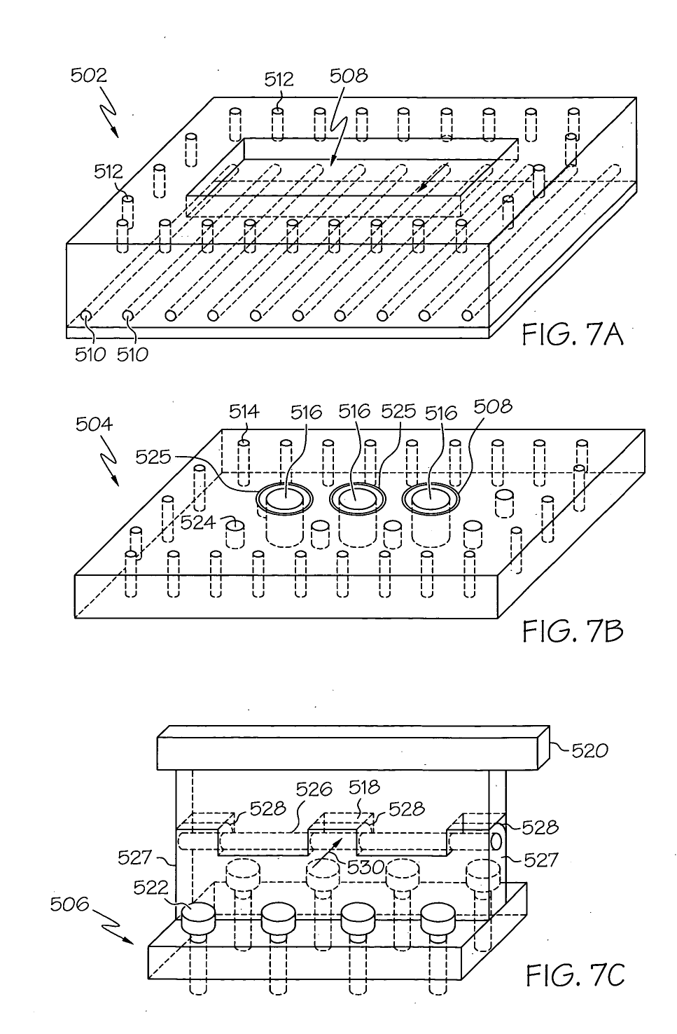

The machine 300 shown in FIG. 3, and the process implemented therewith, is suitable for process development and laboratory scale parts for evaluation. However, it is likely unsuitable for production of large parts, particularly large flat plates suitable for noise absorption. An alternative device that is suitable for relatively large-scale production is shown in simplified schematic form in FIGS. 7A-7C, and will now be described.

The depicted device is a compression mold 500 that includes a base plate 502 (FIG. 7A), a top plate 504 (FIG. 7B), and a movable release plate and mechanism 506 (FIG. 7C). The base plate 502 includes a mold cavity 508, a plurality of heaters 510, and a plurality of threaded cap screw openings 512. Prior to molding, the top plate 504 is preferably secured to the base 502 plate by, for example, inserting threaded cap screws (not shown) through a plurality of cap screw through-holes 514 formed through the top plate 504, and securing the cap screws in the threaded cap screw openings 512 in the base plate 502. The back plate 102 and face plate 104 may then be placed in the mold 500 on the bottom of the cavity 508 and on the bottom surface of the top plate 504, respectively, or preferably may be held in place by a frame (not shown) placed inside the cavity 508. The foamable material 306 and foaming agent 308, in solid or liquid form, are then introduced into the base plate mold cavity 508 via a plurality of cavity-fill through-holes 516 formed in the top plate 504.

Once the foamable material 306 (306 not shown in 7A) and foaming agent are disposed within the mold cavity 508, the release plate 506 is then placed over the top plate 504. A toggle clamp 518, which is held in place by a hydraulic press 520, holds the release plate 506 in place. A plurality of threaded shoulder bolts 522 extend through the release plate 506 and are threaded into threaded shoulder bolt openings 524 formed in the top plate 504. The shoulder bolts 522 limit the upward travel of the release plate 506. Thereafter, the heaters 510 are energized and the foamable material 306 and foaming agent 308 are heated, and the mold cavity 508 thus is pressurized. In the depicted embodiment, a plurality of o-rings 525 surround the through-holes 516 in the top plate 504, and substantially prevent pressure loss due to leakage. In an alternative embodiment, a gaseous blowing agent may be charged through a high-pressure line to the mold 500 prior to melting of the foamable material 306.

By analogy to embodiment depicted in FIGS. 3A-3D, once sufficient pre-cure has taken place, the pressure in the mold cavity 508 is released. This can be done very rapidly by means of the toggle clamp 518, or less rapidly by opening the hydraulic press 520. The toggle clamp 518, as shown most clearly in FIG. 7C, includes two plates 527 coupled to one another by a pin 526, which allows for a hinged motion of the plates 527. One of the edges 528 along each of the adjoining surfaces of the plates 527 is contoured to facilitate folding of the heavily loaded hinge by a small lateral force, shown as arrow 530. Upon release of the toggle clamp 518, the release plate 506 is accelerated rapidly upward by the force of the released gas, but as mentioned above is stopped by the shoulder bolts 522.

An integrated noise suppression panel made in accordance with the processes disclosed herein includes a foam bulk absorber having an open cell structure with cells having a distribution of sizes about a mean size, and a density gradient between the back plate and face plate. As such, the foam bulk absorber described herein provides broadband absorption, as compared to presently known materials.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of forming a foam, comprising the steps of:
pressurizing a foaming agent and a thermoset polymer in a closed vessel;
heating the pressurized foaming agent and the thermoset polymer, to thereby raise the temperature thereof; and
decompressing the pressurized and heated foaming agent and thermoset polymer at a decompression rate that is sufficiently rapid to form a foam having a plurality of open cells formed therein.

2. The method of claim 1, wherein the foaming agent and the thermoset polymer are pressurized and decompressed between a back plate and a face plate.

3. The method of claim 1, wherein the foaming agent is an atmospheric gas.

4. The method of claim 3, wherein the atmospheric gas is carbon dioxide.

5. The method of claim 4, wherein the carbon dioxide is introduced in solid form and generates high pressures during sublimation thereof.

6. (canceled)

7. (canceled)

8. The method of claim 6 further comprising:
curing the decompressed foaming agent and the thermoset polymer for a predetermined period of time.

9. The method of claim 8, wherein the step of curing comprises:
raising the temperature of the decompressed foaming agent and the thermoset polymer to an elevated temperature; and
holding the temperature of the decompressed foaming agent and the thermoset polymer at the elevated temperature for a predetermined time period.

10. The method of claim 1, further comprising:
bonding a back plate and a face plate to the foam to form a noise suppression acoustic panel.

11. The method of claim 1, further comprising:
disposing the foaming agent and the thermoset polymer between aback plate and a face plate; and
securing the back plate and face plate in fixed positions so that the foam has a predetermined geometry.

12. The method of claim 1, wherein the compressing and decompressing steps are performed using a compression molding machine.

13. The method of claim 1, wherein:
the rate of decompression is controlled by mechanical means.

14. The method of claim 13, wherein the mechanical means comprises a toggle clamp.

15. The method of claim 13, wherein the mechanical means comprises a hydraulic cylinder.

16. The method of claim 2, wherein:
the back plate is substantially imperforate; and
the face plate is at least partially perforated.

17. The method of claim 1, wherein the formed foam has at least a first side and a second side, and further has a density gradient between the first and second sides.

18. A method of forming an open cell foam noise suppression panel, comprising the steps of:
disposing a foaming agent and a foamable material between at least a back plate and a face plate;
pressurizing the foaming agent and the foamable material between the back plate and face plate;
heating the pressurized foaming agent and the foamable material, to thereby raise the temperature thereof; and
decompressing at a decompression rate, the pressurized and heated foaming agent and foamable material between the back plate and the face plate,
wherein the decompression rate is sufficiently rapid to form a plurality of open cells in the foamable material, to thereby form the open cell foam noise suppression panel between the back plate and the face plate.
